(19) United States
(12) Patent Application Publication
(10) Pub. No.: US 2011/0278158 A1
(43) Pub. Date: Nov. 17, 2011

(54) ELECTROLYTIC CHLORINATOR

(76) Inventors: Rodney Briggs, Mordialloc (AU); Darren William Ford, Noble Park (AU)

(21) Appl. No.: 13/146,717

(22) PCT Filed: Jan. 28, 2010
(86) PCT No.: PCT/AU2010/000083

§ 371 Date: Jul. 28, 2011

(30) Foreign Application Priority Data
Jan. 29, 2009 (AU) 2009900325

(51) Int. Cl. C25B 1/26; B08B 3/08; C25B 15/02; B08B 3/10

(52) U.S. Cl. 204/227; 134/34; 134/1; 134/58 R; 134/57 R

(57) ABSTRACT

A method of cleaning one or more electrodes (30) of an electrolytic chlorinator (10). The electrodes are immersed in water within a chamber (120). The method includes the steps of substantially stopping water flow through the chamber; supplying a volume of cleaning agent into the chamber; and agitating the water and the cleaning agent within the chamber to form a cleaning agent water mixture and to bring the cleaning agent water mixture into intimate contact with the one or more electrodes thereby cleaning the electrodes. According to preferred forms of the method, the agitation step includes activating the electrodes to liberate hydrogen and oxygen bubbles. The invention also provides an electrical driver (200) for controlling cleaning of the electrodes in accordance with the method, and an electrolytic chlorinator (10) including an agitator for agitating the water and the cleaning agent within the chamber to form a cleaning agent water mixture and to bring the cleaning agent water mixture into intimate contact with the one or more electrodes thereby cleaning the electrodes. The invention also provides an electrolytic chlorinator for having a housing (50) defining a chamber, an inlet (110A) for water to flow into the chamber, and an outlet (110B) for water to flow out of the chamber. Spaced electrodes (30) are arranged within the chamber for receiving power from a DC power supply to electrolyse the water. A cleaning agent retainer (160) is located within the chamber for preventing cleaning agent sinking from the chamber.

### FIELD OF THE INVENTION

The invention relates to electrolytic chlorinators. Certain electrolytic chlorinators are used to sterilize pool water.

Throughout this specification, the term ‘pool’ includes in its ambit any kind of confined water body in which humans can be immersed, including spas, swim spas and Japanese-style immersion tubs.

### BACKGROUND OF THE INVENTION

Mono-polarity electrolytic chlorinators work by passing a direct electric current through a stream of the pool water. The electric current has the effect of temporarily converting anions (predominantly chlorine ions) associated with dissolved salts back into their elemental state. In this way elemental chlorine is intimately contacted with the water which has the effect of sanitising the water by killing undesirable biological entities. The electrodes are driven at a voltage such that the products of electrolysis are readily reabsorbed into the water.

An unfortunate consequence of this electrolytic reaction is the conversion of cations (predominately calcium ions) back to their elemental state. This can cause calcium build-up on the cathode which creates an impedance that reduces the performance of the electrolytic cell.

‘Bipolarity’ chlorinators address the problem of calcium build-up by driving an alternating electric current between the electrodes. This is effective in reducing the calcium build-up but has serious drawbacks including the rapid erosion of the electrodes. This problem has in turn been addressed by expensive coatings seeking to reduce the erosion of the electrodes. The net result is that commercial ‘bipolarity’ chlorinators whilst effectively avoiding the problems associated with calcium build-up are relatively expensive and still have a less than satisfactory electrode life.

Mono-polarity chlorinators can be operated effectively by periodically cleaning off the accumulated calcium. The usual approach involves removing the electrodes from the chamber and manually immersing the electrodes in a hydrochloric acid solution. This manual cleaning operation is both labour intensive and hazardous. The electrodes typically require cleaning on a weekly basis. The hydrochloric acid can burn the skin and is highly toxic.

A conventional form of mono-polarity chlorinator includes electrodes packaged within a housing defining a chamber. The housing includes an inlet and an outlet for water flow through the chamber. The inlet and the outlet both project downwardly from the chamber so that the chamber is upwardly closed. This arrangement is a precaution in case of a failure resulting in the production of hydrogen and oxygen. By having the electrodes mounted in an upwardly closed chamber any hydrogen and oxygen so produced is readily captured and detected such that safety interlocks can deactivate the electrodes.

International Patent Application No. WO 96/11166 describes one attempt to address the difficulties of cleaning the electrodes of such mono-polarity chlorinators. The international application describes cleaning the electrodes in situ by periodically stopping the water flow through the chamber and injecting a quantity of acid into the interior of the chamber. This arrangement has been found to be less than satisfactory in cleaning the electrodes.

International Patent Application No. WO 2005/033015 describes an acid free approach to cleaning the electrodes. An ultrasonic transducer is used to cause ultrasonic vibrations throughout the liquid contained in the housing.

It is an object of the invention to provide an improved chlorinator or at least provide an alternative in the market.

### SUMMARY OF THE INVENTION

The applicant has realised that the unsatisfactory results obtained with arrangements such as that shown in International Patent Application No. WO 96/11166 are related to the acid failing to satisfactorily contact the electrodes. Experiments using tracer dyes have shown that the injected acid is relatively dense and rather than mixing with the water in the chamber and intimately contacting the electrodes, most of the acid simply sinks and escapes from the chamber via either the inlet or the outlet without effectively acting on the calcium deposits.

Accordingly a first aspect of the invention relates to an electrolytic chlorinator having cleaning agent retention means for preventing the acid, or other cleaning agent, sinking from the chamber. A second aspect of the invention relates to agitating the water and the cleaning agent within the chamber to form a cleaning agent water mixture and to bring the cleaning agent water mixture into intimate contact with the electrodes thereby cleaning the electrodes.

In the first aspect of the invention there is provided an electrolytic chlorinator having:
a housing defining a chamber, an inlet for water to flow into the chamber, an outlet for water to flow out of the chamber;
spaced electrodes arranged within the chamber for receiving power from a DC power supply to electrolyse the water; and
cleaning agent retention means within the chamber for preventing cleaning agent sinking from the chamber.

The chlorinator may include a dedicated cleaning agent inlet. The cleaning agent retention means preferably includes an upwardly open receptacle, such as a trough, and is most preferably positioned at least approximately vertically downwardly from the cleaning agent inlet for receiving cleaning agent sinking from the cleaning agent inlet. The cleaning agent inlet may be an aperture in a wall portion partly defining the chamber and from which the cleaning agent retention means extends. The receptacle forming the cleaning agent retention means is preferably formed by an integrally formed portion attachable to the wall portion. The electrodes are preferably connectable to a DC power supply via apertures in the wall portion. The wall portion is preferably removable from a main body of the housing, the main body predominantly defining the housing.

The cleaning agent retention means may include at least one closure for selectively substantially closing one or both of the inlet and the outlet. The or each closure is preferably a valve, most preferably a non-return valve. The valve may be biased to a closed position. Preferably each of the inlet and the outlet is provided with a respective closure. The closures may include like components, the components of each closure being differently arranged to respectively suit the inlet and the outlet.

The chlorinator advantageously includes agitation means for agitating the cleaning agent and water within the chamber to remove cleaning agent from the cleaning agent retention means and to mix the cleaning agent and water within the chamber to form a cleaning agent water mixture and to bring the cleaning agent water mixture into intimate contact with the electrodes for cleaning the electrodes. Of course mixing does occur when the cleaning agent is received within the chamber via the cleaning agent inlet, but improved results have been achieved by providing agitation means.

In either aspect the agitation means preferably includes the electrodes and an electrical driver including the DC power supply and a controller, the DC power supply being operatively connectable to the electrodes, the controller being configured to control the DC power supply to drive the electrodes, when flow through the chamber is substantially stopped, to liberate hydrogen and oxygen bubbles to agitate the water and the cleaning agent within the chamber. Most preferably the chlorinator includes an electrical driver in accordance with the second aspect of the invention. The controller may be operatively connectable to a pump for driving water through the chamber and configured to in use substantially stop the pump.

The chlorinator may include a cleaning agent supply for supplying cleaning agent to the chamber.

Preferably the inlet and the outlet are arranged in an in use lower portion of the chamber. Most preferably the inlet and the outlet are arranged to in use downwardly open from the chamber.

In the second aspect of the invention there is provided a method of cleaning one or more electrodes of an electrolytic chlorinator wherein the electrodes are immersed in water within a chamber, the method including the steps of:
substantially stopping water flow through the chamber;
supplying a volume of cleaning agent into the chamber; and
agitating the water and the cleaning agent within the chamber to form a cleaning agent water mixture and to bring the cleaning agent water mixture into intimate contact with the one or more electrodes thereby cleaning the electrodes.

The cleaning agent is preferably injected into the chamber via a cleaning agent inlet.

The agitation step preferably lasts for between 2 and 20 seconds, most preferably around 5 seconds and most preferably includes activating the electrodes to liberate hydrogen and oxygen bubbles.

There is preferably a delay between the supply of cleaning agent and the agitation step. Preferably the delay is between 1 and 10 minutes, and most preferably is around 5 minutes. According to preferred forms of the invention, at least most of the cleaning agent so supplied is held in cleaning agent retention means within the chamber during the delay.

Advantageously the method may include restarting the water flow through the chamber 1 to 10 minutes, and preferably about 5 minutes, after the agitation step.

The cleaning agent may be an acid, and is preferably hydrochloric acid and most preferably is hydrochloric acid at a strength of about 30 percent prior to supply.

The one or more electrodes may be cleaned by removing deposits on the electrodes that are the product of electrolysis.

The second aspect of the invention also provides an electrolytic chlorinator having:
a housing defining a chamber, an inlet for water to flow into the chamber, and an outlet for water to flow out of the chamber;
spaced electrodes arranged within the chamber for receiving power from a DC power supply to electrolyse the water; and
agitation means for mixing cleaning agent and water within the chamber to form a cleaning agent water mixture and to bring the cleaning agent water mixture into intimate contact with the electrodes for cleaning the electrodes.

The second aspect of the invention also provides an electrical driver for driving an electrolytic chlorinator:
the electrolytic chlorinator including spaced electrodes within a chamber;
the electrical driver including a DC power supply, for driving the electrodes, and a controller;
the controller being configured to control:
(i) the DC power supply,
(ii) a cleaning agent supply for supplying cleaning agent to the chamber, and
(iii) a pump for pumping water through the chamber;
to clean the electrodes in accordance with the method of the second aspect of the invention.

The DC power supply is preferably configured to receive an AC mains supply and to convert power received therefrom to DC. For this purpose the DC power supply may include a transformer and a rectifier. The DC power supply preferably produces about 9 volts in the range of 20-25 amps DC current.

The electrical driver may include a pump for pumping cleaning agent from the cleaning supply to the chamber. Desirably the components of the electrical driver may be mechanically joined, or packaged within a common housing, for sale as a single unit.

Preferably the controller includes, or is connectable to, an interface and is configured to receive user input from the interface and to vary cleaning cycle parameters in response to the user input. Preferred forms of the controller include default cleaning cycle parameters. It is desirable that a user should be able to adjust the frequency of cleaning.

The various aspects of the invention are complementary and each aspect may incorporate the features of the other aspects.

### BRIEF DESCRIPTION OF THE DRAWINGS

The figures illustrate electrolytic chlorinators according to preferred forms of the invention.

FIG. 1 is a perspective view of an electrolytic chlorinator embodying various aspects of the invention;

FIG. 2 is a perspective view of an inner end of an end plug;

FIG. 3 is a perspective view of an outer end of an end plug;

FIG. 4 is a partial vertical axial cross section view of the electrolytic chlorinator;

FIG. 5 is an exploded view of the electrolytic chlorinator;

FIG. 6 is an outer end view of the end plug;

FIG. 7 is a side view of the end plug;

FIG. 8 is horizontal axial cross section view of the end plug on the line C-C shown in FIG. 6;

FIG. 9 is an inner end view of the end plug;

FIG. 10 is a partial vertical axial cross section view of the end plug on the line E-E in FIG. 9;

FIG. 11 is a schematic representation of the main body, the control means and the cleaning agent supply; and

FIG. 12 is a vertical cross section view of an electrolytic chlorinator according to an alternative embodiment of the invention.

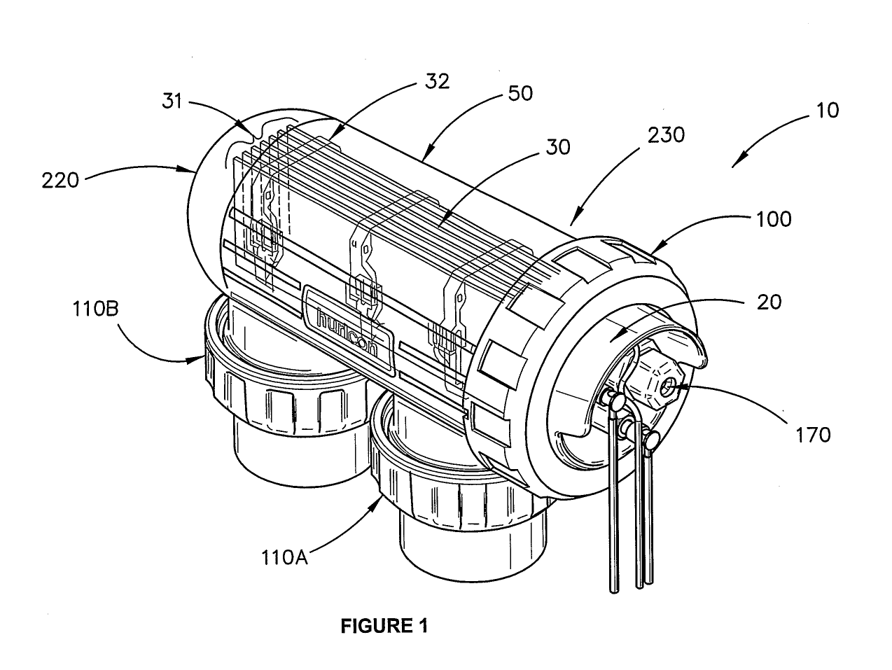

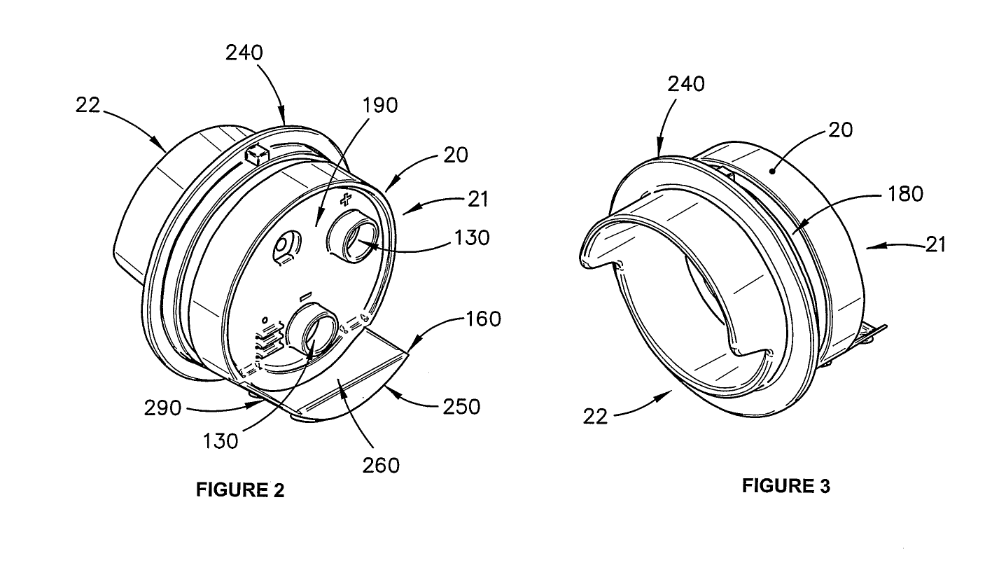

### DETAILED DESCRIPTION OF THE EMBODIMENTS

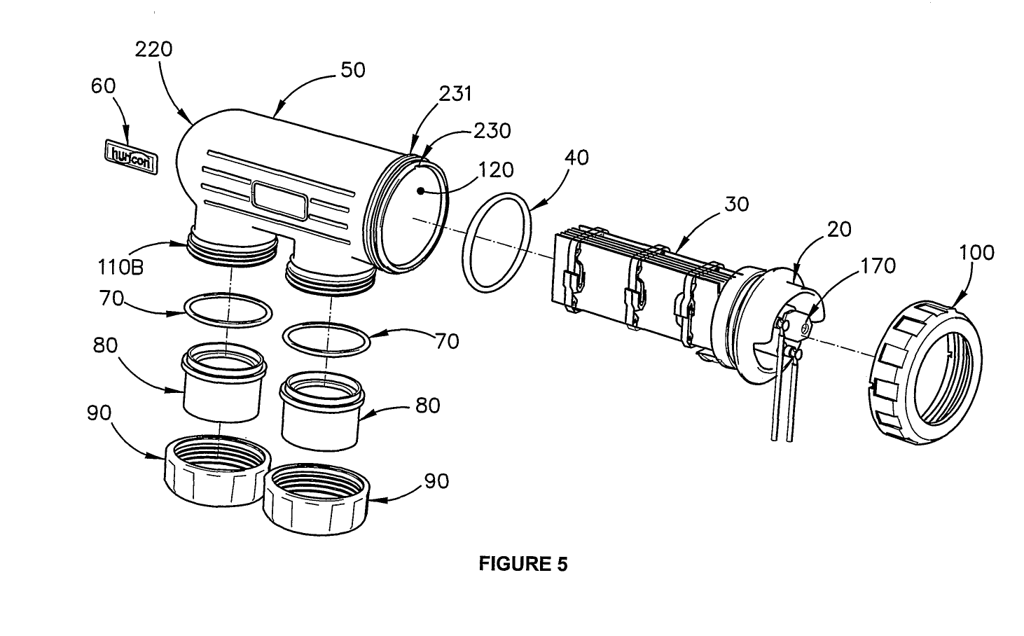

The electrolytic chlorinator 10 includes a main body 50 having a predominantly cylindrical form. The body 50 has a closed domed end 220 and an open end 230 which has an external thread 231 (FIG. 5) about its outer periphery. An end plug 20 is receivable within the open end 230 of the main body 50 to define a chamber 120 within the main body 50. In its operative position, main body 50 is mounted with its central axis horizontal.

Inlet 110A and outlet 110B depend downwardly from the main body 50 at axially spaced locations in a vertical plane that includes the central axis of the main body 50. The inlet 110A and the outlet 110B each include a short vertical cylindrical tubular body extending to a downwardly open end having an external thread about its periphery. As best illustrated in FIG. 5, each of the inlet 110A and the outlet 110B is adapted to sealingly communicate with a respective pipe end portion 80. Each pipe end portion 80 includes an outwardly extending flange about its periphery. A respective collar 90 is received about each pipe end portion 80 and threadingly engages with the external thread about the periphery of the respective inlet/outlet 110A, 110B to compress an annular gasket 70 between the flange of the respective pipe end portion 80 and a respective end face of the inlet/outlet 110A, 110B.

The end plug 20 is predominantly in the form of a hollow cylinder having a diameter slightly larger than its length and is in situ concentrically aligned with and received within the main body 50. An end 21 of the end plug 20 is closed by an integral wall 190 which in this embodiment is substantially planar and perpendicular to the central axis of the end plug 20. This closed end 21 is in use received within the main body 50. The other end 22 of end plug 20 is open and in use projects outwardly from the main body 50.

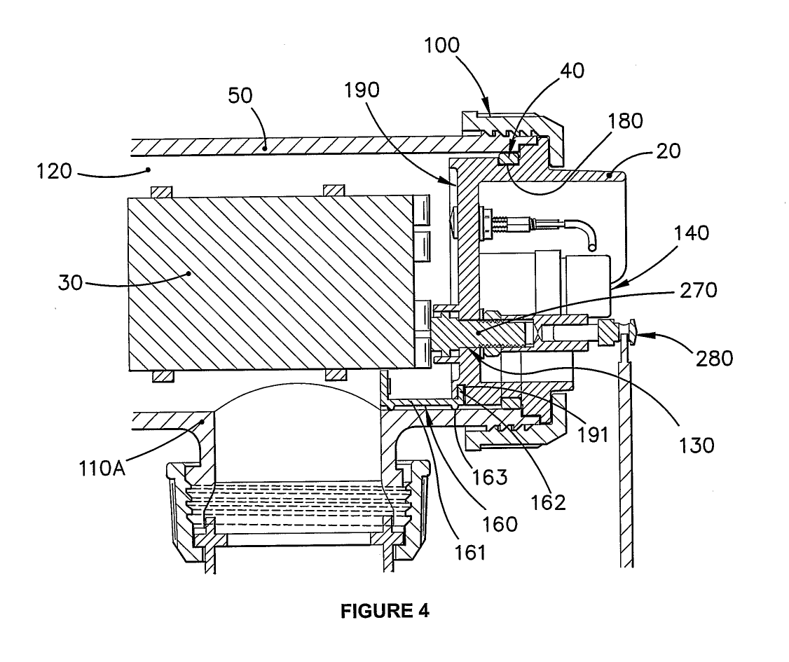

As best illustrated in FIG. 4 the end plug 20 includes an O-ring groove 180 in its outer cylindrical surface in which in use an O-ring 40 is received and forms a piston seal against the internal cylindrical surface of the main body 50. The end plug 20 includes an outwardly extending peripheral flange 240 which is in use clamped against an end face of the main body 50 by the threading engagement of a collar 100 with the external thread 231 of the main body 50.

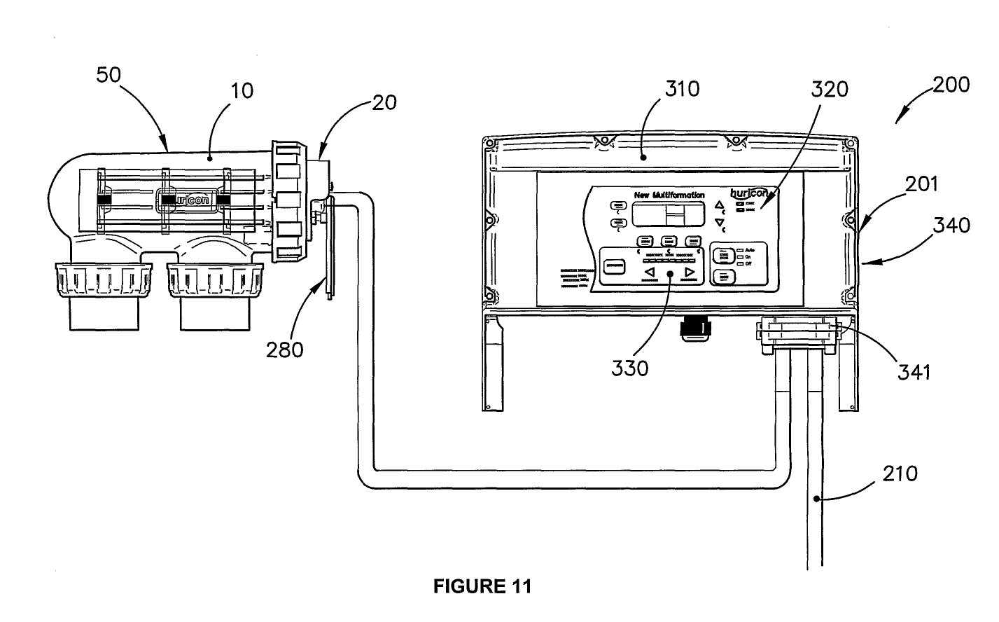

The end plug 20 includes electrode apertures 130 passing through the wall 190 at in use vertically and horizontally spaced locations. Electrodes 30 are mechanically supported in cantilever fashion by fasteners 270 (see FIG. 4) passing through electrode apertures 130. The electrodes 30 are electrically communicated with electrical driver 200 (see FIG. 11) by electrical wires 280 connecting to portions of the fasteners 270 projecting outwardly beyond the electrode apertures 130.

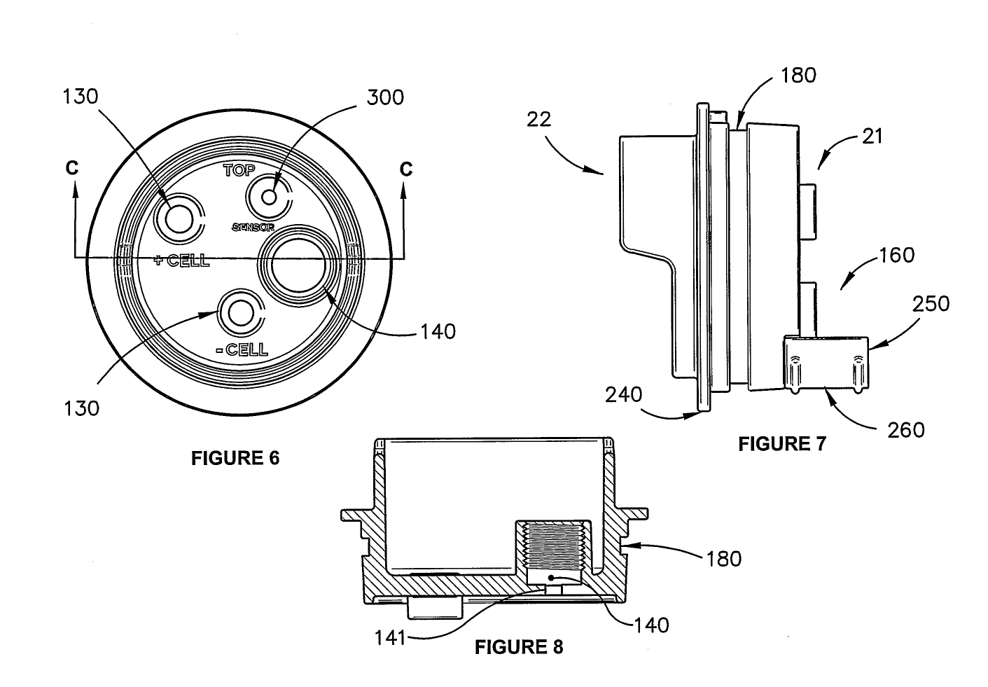

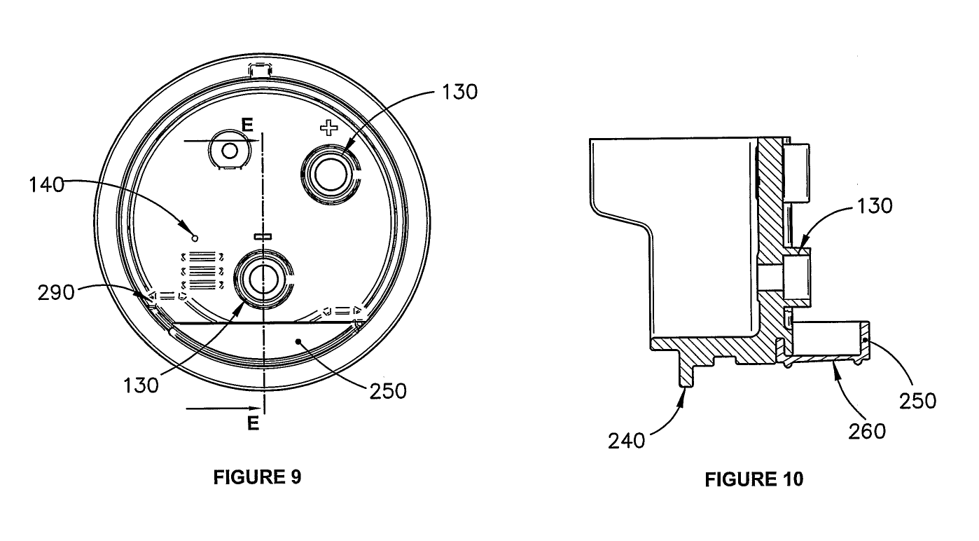

The wall 190 of end plug 20 also includes an acid inlet 140 in the form of a cylindrical aperture having an internal thread as illustrated. In use gland 170 is received within and threadingly engaged with the internal thread of the acid inlet 140. Through the gland 170 acid injection means (not shown) are provided for injecting acid into the chamber 120. As illustrated in FIG. 6, the acid inlet 140 is positioned toward one side of the end plug 20. An inner end of the acid inlet 140 is closed but for a small aperture 141 (see FIG. 8). The aperture 141 is preferably drilled thereby allowing a common end plug moulding to be used for applications that do not require the acid inlet.

As best illustrated in FIG. 4 the end plug 20 includes cleaning agent retention means in the form of trough 160 extending from wall 190 to in use project into the chamber 120 and underlie the acid inlet 140. The trough member 161 is an integrally formed piece attachable to the wall 190, which is also integrally formed. The trough member 161 includes an upright wall portion 162 and a horizontal wall portion 260 extending from the wall portion 162 to an upright end wall 250. The plug 20 includes an outwardly open groove 191 in which the wall portion 162 is frictionally fitted so that when the plug 20 is received in the body 50 the trough member 161 is captured and held in place. Ribs 163 about an outer surface of the wall portion 260 contact an inner surface of the body 50 to locate the trough member 161 during and after assembly. The trough 160 is defined by a wall portion 260 extending from the wall 190 to a short upright end wall 250. Viewed from chamber 120, the wall portion 260 has an arcuate cross-section which is concentric with and closely fits within the main body 50. The end wall 250 is planar and parallel to the wall 190. The end wall 250 terminates at a height of about 13 mm above the lower extent of the wall portion 260 being the maximum permissible height to avoid fouling the electrodes 30 (see FIG. 4). In this embodiment the trough 160 has a capacity of about 15 mL.

At one side of the trough 160 a guide 290 is formed by a small portion of the wall portion 260 extending 5 mm above the upper extent of the end wall 250. As illustrated the other side of the wall portion 260 terminates at the same height as the end wall 250. The guide 290 is arranged toward the same side of the end plug 20 as the acid inlet 140 to assist in capturing within the trough 160 a greater portion of the injected acid.

FIG. 6 illustrates the layout of the electrode apertures 130 and the acid inlet 140 across a face of the wall 190 which is in use disposed outwardly from the chamber 120. A sensor aperture 300 extends through the wall 190 and in use receives a sensor for detecting low salt levels or no water conditions.

The electrodes 30 are made up of multiple, in this case seven, parallel spaced rectangular mesh sheets 31. In use the mesh sheets 31 are vertically orientated. Sheets 31 are electrically connected to a DC power supply 310 (described below) so as to define two sets of interleaved sheets of differing polarity. The sheets 31 are held in relative disposition and mutually isolated by spacers 32.

In normal operation water flows into the chamber 120 via the inlet 110A and flows out via the outlet 1108. The illustrated electrolytic chlorinator 10 is operated as a mono-polarity chlorinator, i.e. a direct current from the DC power supply 310 is passed through the water between the electrodes 30.

As best shown in FIG. 11, the electrical driver 200 includes the DC power supply 310 and control means 320 and is operatively connected to an acid supply 210, to the electrodes 30 and to a pool pump (not shown). The control means 320 includes a programmable microprocessor programmed to operate the chlorinator including to actuate the steps of a cleaning cycle (described below) and is thereby configured to control cleaning of the electrodes. In this embodiment the electrical driver 200 also includes an acid pump 340 which includes mechanical pump components 341. The DC power supply 310, the control means 320 and electrical pump components (not shown) are packaged in a common housing 201. The mechanical pump components 341 are mechanically joined to an underside of the housing 201 for the electrical driver 200, including housing 201 and mechanical pump components 341, to be sold as a single unit.

During the cleaning cycle the control means 320 is operative to deactivate the pool pump to stop the water flow through the chamber 120. The control means 320 then activates an acid pump 340 for approximately 20 seconds to draw from the acid supply 210 and supply to the chamber 120 via the acid injection means about 20 ml of hydrochloric acid of 30% strength. A portion of the acid mixes with the water and immediately begins to act on any deposits on the electrodes. However, because the acid is denser than the water, most of the acid sinks rapidly and accumulates in the trough 160. Thereafter the electrolytic chlorinator 10 remains dormant for approximately five minutes for the mixed portion of the acid to act on any deposits on the electrodes 30. The electrodes 30 are then energised for five seconds by DC power supply 310 under the control of the control means 320. This activation of the electrodes 30 in the absence of water flow results in electrolysis of the water which causes bubbles of hydrogen and oxygen to form on respective electrodes. As further bubbles form, bubbles are liberated to rise through the water to create an effective circulation and agitation of the water and acid within the chamber 120. The electrodes 30 and electrical driver 200, including the DC power supply 310 and control means 320, thereby form the agitation means in this embodiment.

It has been observed that the rising of bubbles from the electrodes 30 generates water flow in the area that it is needed most, i.e. immediately adjacent the surfaces of the electrodes 30. This water flow within the chamber 120 defines a recirculating pattern including flow upwardly in line with the moving bubbles from electrodes 30 and downwardly along the vertical wall 190. This vertically downward flow along the wall 190 impinges on the trough 160 and thus entrains the acid accumulated therein to form an acid water mixture within the chamber 120. The recirculating pattern is completed by the water including entrained acid being upwardly drawn through the electrodes 30.

After the five second activation of the electrodes the chlorinator is again allowed to sit dormant for a further five minutes. During this period the acid water mixture within the chamber 120 is able to act on the deposits on the cathode surfaces. The pool pump (not shown) is then reactivated by the control means 320. The acid water mixture, including dissolved calcium, is thus purged from the chamber 120 and flows back to the pool (not shown) via the outlet 110B. The acid water mixture is of course of lesser strength than the injected acid and in transit to and upon arrival within the pool is rapidly dispersed and thus does not present a safety hazard.

The electrical driver includes an interface 330 including an LCD display and keys by which a user may vary the operation of the control means 320. Although other variations are possible, in this embodiment the control means 320 includes a default setting. A user can vary the default setting to change the frequency of cleaning to suit local conditions. For example, in the case of ‘hard’ water more frequent cleaning may be required. On the other hand, with soft water, the frequency of cleaning can be reduced thereby conserving acid and extending the electrode life.

It is also envisaged that the control means be cooperable with, or indeed formed by, a computer, such as a PC, in which case the computer may form the interface.

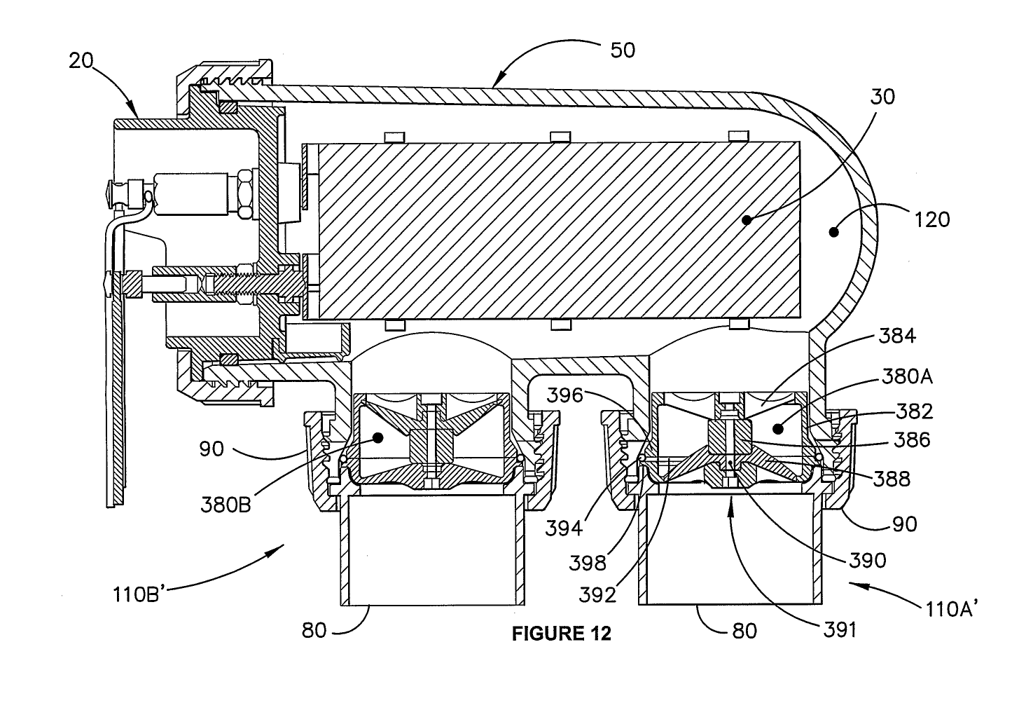

FIG. 12 illustrates an alternative embodiment of the invention including non-return valves 380A and 380B respectively mounted in inlet 110A′ and outlet 110B′. The valves 380A,380B constitute selectively openable closures for preventing cleaning agent sinking from the chamber 120. FIG. 12 shows the valves in their closed position.

Each valve 380A, 380B includes a cylindrical tubular body 382 spanned by set of radial spokes 384 at each end. Openings (not shown) between the spokes 384 allow water to flow through the valve when the valve is open.

The body 382 of each valve 380A, 380B is co-axially aligned with the respective inlet 110A′ or outlet 110B′ in which it is mounted. An exterior of the each body 382 includes a tapered portion 396 which nests within a complementary tapered portion about the interior of the respective inlet or outlet.

Each body 382 includes by a groove 392 extending circumferentially about its exterior and positioned axially between a thicker end of the tapered portion 396 and a peripheral flange 398 which extends circumferentially about the exterior of the body 382. An O-ring seal 394 is carried in each groove 392 to bear against, and form a piston seal with, the interior of the inlet or outlet.

The pipe end portions 80, are held in place by collars 90 as in the previously described embodiment. Each pipe end portion overlies a respective peripheral flange 398 to retain a respective valve.

The spokes 384 within each set of spokes converge to define a respective central hub 391 and are shaped to present a respective shallow conical surface to an interior of the respective body 382. Within each valve 380, a shaft 390 extends axially from the central hub 391 at one end of the body 382 to the central hub 391 at the other end.

Each shaft 390 carries a spacer 386 and a valve member in the form of a silicon (or rubber) ‘flap’ 388 within the interior of the valve body 382. The flap 388 is conically domed and resiliently flexible so as to be biased to the illustrated closed position wherein the flap 388 overlies, and is seated against, a shallow conical surface defined by a set of spokes 384 to close the openings between the spokes and thereby stop water flow through the valve.

The valves are arranged so that pressure driving fluid in a ‘reverse flow’ direction (i.e. inward, toward the chamber, via the outlet 110B′ and outward, away from the chamber 120, via the inlet 110A′) will tend to drive the valves to the closed position to prevent such flow; and that, conversely, flow in the ‘forward direction’ will tend to lift flaps 388 away from the spokes 384 to open the valves so that such flow is permitted.

In operation of the chlorinator, the pool pump drives the water in the forward direction and thus the valves remain open. During a cleaning cycle, when the pump is stopped the valves 380A, 380B return to the closed position under there own bias and thus operate to prevent cleaning agent sinking from the chamber 120.

As illustrated the valves 380A and 380B include like components (body 382, spokes 384, shaft 390, flap 388 and spacer 386). The components of each valve are arranged differently to respectively suit operation within the inlet 110A′ and the outlet 110B′.

Within valve 380A, which is mounted within the inlet 110A′, the flap 388 is mounted adjacent the spokes 384 at the outer end of the body 382 (i.e. the end furthest from the chamber 120). The flap 388 is held in place by spacer 386 spacing the flap 388 from the hub 391 at the inner end of the valve 380A. As such an inward flow (i.e. flow toward the chamber 120) lifts flap 388.

Within valve 380B, which is mounted within the outlet 110B′, the relative positions of the flap 388 and the spacer 386 is reversed whereby inward flow is prevented.

The use of common components within the valves of course has advantages including improved economies of scale and stock control.

It will be understood that the invention disclosed and defined in this specification extends to all alternative combinations of two or more of the individual features mentioned or evident from the text or drawings. All of these different combinations constitute various alternative aspects of the invention.

1. An electrolytic chlorinator having:
a housing defining a chamber, an inlet for water to flow into the chamber, an outlet for water to flow out of the chamber;
spaced electrodes arranged within the chamber for receiving power from a DC power supply to electrolyse the water; and
agitation means for mixing cleaning agent and water within the chamber to form a cleaning agent water mixture and to bring the cleaning agent water mixture into intimate contact with the electrodes for cleaning the electrodes.

2. The chlorinator of claim 1, wherein the agitation means includes the electrodes and an electrical driver, including the DC power supply, for driving the electrodes, when flow through the chamber is substantially stopped, to liberate hydrogen and oxygen bubbles to agitate water and cleaning agent within the chamber.

3. The chlorinator of claim 1 further including cleaning agent retention means within the chamber for preventing cleaning agent sinking from the chamber.

4. The chlorinator of claim 3 wherein the cleaning agent retention means includes an upwardly open receptacle.

5. The chlorinator of claim 4 further including a cleaning agent inlet for receiving cleaning agent into the chamber; wherein the receptacle is positioned at least approximately vertically downwardly from the cleaning agent inlet for receiving cleaning agent sinking from the cleaning agent inlet.

6. The chlorinator of claim 5 wherein the cleaning agent inlet is an aperture in a wall portion partly defining the chamber and from which the cleaning agent retention means extends.

7. The chlorinator of claim 6 wherein the receptacle is formed by an integrally formed portion attachable to the wall portion.

8. The chlorinator of claim 6 wherein the electrodes are cooperable with a DC power supply via apertures in the wall portion and the wall portion is removable from a main body of the housing which predominantly defines the housing.

9. The chlorinator of claim 3 wherein the cleaning agent retention means includes at least one non-return valve biased to the closed position for selectively substantially closing one or both of the inlet and the outlet.

10. The chlorinator of claim 1 further including a cleaning agent supply for supplying cleaning agent to the chamber.

11. A method of cleaning one or more electrodes of an electrolytic chlorinator wherein the electrodes are immersed in water within a chamber, the method including the steps of:
substantially stopping water flow through the chamber;
supplying a volume of cleaning agent into the chamber; and
agitating the water and the cleaning agent within the chamber to form a cleaning agent water mixture and to bring the cleaning agent water mixture into intimate contact with the one or more electrodes thereby cleaning the electrodes.

12. The method of claim 11, wherein the agitation step includes activating the electrodes to liberate hydrogen and oxygen bubbles.

13. The method of claim 12 wherein the agitation step lasts for between 2 and 20 seconds.

14. The method of claim 13, wherein the agitation step lasts for around 5 seconds.

15. The method of claim 11 further including delaying between the supply of cleaning agent and the agitation step.

16. The method of claim 15 wherein the delay is between 1 and 10 minutes.

17. The method of claim 16 wherein the delay is around 5 minutes.

18. The method of claim 11 further including restarting the water flow through the chamber between 1 to 10 minutes after the agitation step.

19. The method of claim 18 further including restarting the water flow about 5 minutes after the agitation step.

20. The method of claim 11 wherein the cleaning agent is an acid.

21. The method of claim 20 wherein the cleaning agent is hydrochloric acid.

22. The method of claim 21 wherein the hydrochloric acid is at a strength of about 30 percent prior to said supplying.

23. An electrical driver for driving an electrolytic chlorinator, the electrolytic chlorinator including spaced electrodes within a chamber;
the electrical driver including a DC power supply, for driving the electrodes, and a controller;
the controller being configured to control:
(i) the DC power supply,
(ii) a cleaning agent supply for supplying cleaning agent to the chamber, and
(iii) a pump for pumping water through the chamber;
to clean of the electrodes in accordance with the method of claim 11.

24. The electrical driver of claim 23 wherein the DC power supply is configured to receive an AC mains supply and to convert power received therefrom to DC.

25. The electrical driver of claim 24 wherein the DC power supply includes a transformer and a rectifier.

26. The electrical driver of claim 23, wherein the DC power supply produces about 9 volts in the range of 20 to 26 amps DC current.

27. The electrical driver of claim 23 further including a pump for pumping cleaning agent from the cleaning supply to the chamber.

28. The electrical driver of claim 23 wherein the controller is configured to receive user input from an interface and to vary cleaning cycle parameters in response to the user input.

29. The electrical driver of claim 28 wherein the controller is configured to vary frequency of cleaning in response to a user input.

30. The chlorinator of claim 1 wherein the agitation means includes the spaced electrodes and further includes the electrical driver of claim 23.

31. An electrolytic chlorinator having:
a housing defining a chamber, an inlet for water to flow into the chamber, an outlet for water to flow out of the chamber;
spaced electrodes arranged within the chamber for receiving power from a DC power supply to electrolyse the water; and
cleaning agent retention means within the chamber for preventing cleaning agent sinking from the chamber.

32. The chlorinator of claim 31 wherein the cleaning agent retention means includes an upwardly open receptacle.

33. The chlorinator of claim 32 further including a cleaning agent inlet for receiving cleaning agent into the chamber; wherein the receptacle is positioned at least approximately vertically downwardly from the cleaning agent inlet for receiving cleaning agent sinking from the cleaning agent inlet.

34. The chlorinator of claim 33 wherein the cleaning agent inlet is an aperture in a wall portion partly defining the chamber and from which the receptacle extends.

35. The chlorinator of claim 34 wherein the receptacle is formed by an integrally formed portion attachable to the wall portion.

36. The chlorinator of claim 34 wherein the electrodes are cooperable with the DC power supply via apertures in the wall portion and the wall portion is removable from a main body of the housing which predominantly defines the housing.

37. The chlorinator of claim 31 wherein the cleaning agent retention means includes at least one closure for selectively substantially closing one or both of the inlet and the outlet.

38. The chlorinator of claim 37 wherein the or each closure is a non-return valve biased to a closed position.

39. The chlorinator of claim 37 wherein each of the inlet and the outlet is provided with a respective closure.

40. The chlorinator of claim 39 wherein the closures include like components, the components of each closure being differently arranged to respectively suit the inlet and the outlet.
